(19) United States
(12) Patent Application Publication
(10) Pub. No.: US 2006/0241248 A1
(43) Pub. Date: Oct. 26, 2006

(54) Glazing joint

(75) Inventors: Paul David Foreman, Kent (GB); Andrew Zarebski, Herefordshire (GB)

Correspondence Address: BURNS & LEVINSON, LLP;(FORMERLY PERKINS SMITH & COHEN LLP), 125 SUMMER STREET, BOSTON, MA, 02110, US

(73) Assignee: Eye-Bond Limited, Basildon, Essex (GB)

(21) Appl. No.: 10/533,481

(22) PCT Filed: Oct. 15, 2003
(86) PCT No.: PCT/GB03/04467

§ 371 Date: May 11, 2006

(30) Foreign Application Priority Data
Oct. 31, 2002 (GB) 0225372.2

(51) Int. Cl. C08L 83/04; C09J 7/02; C09J 183/04; B32B 27/00

(52) U.S. Cl. 525/477; 156/106; 156/329

(57) ABSTRACT

A composition for glazing joints comprises (a) a siloxane polymer having a molecular weight of from 300,000 to 700,000, (b) a siloxane polymer having a molecular weight of from 10,000 to 100,000 (the ratio of component A to component B being in the range of from 10 to 1, to 3 to 1) and a cross linking agent. The composition is preferably sufficiently cross-linked to have an effective surface tackiness. A glazing strip (10) shaped for receiving two or more sheets may be formed from the composition. An advantage of the composition is that it remains adhesive so that in use, this allows glass sheets to be repositioned and removed when dismantling a partition wall.

The present invention relates to a composition for use as a glazing joint, especially for glazed partition walls.

Glazed partition walls are formed by joining a series of frameless glass sheets. Adjacent edges of the glass sheets are typically joined by coating the edge of a first glass sheet with a sealant, such as silicone or mastic, then positioning the edge of a second glass sheet against the coated edge of the first sheet. A problem with this method is that excess sealant is pushed out of the joint and onto adjacent surfaces of the glass sheets and has to be removed, for example by wiping whilst the sealant is still fluid. This results in an inconsistency in the quality of the finish of the joints. Furthermore, gaining access to both sides of the glazed partition wall in order to remove excess sealant can prove difficult.

UK patent 2,322,663 describes a glazing joint in which an adhesive strip such as double sided adhesive tape, is attached to one side of the joint to stop the silicone from spilling out on that side. Excess silicone pushed out from the other side of the joint still needs to be wiped away.

UK patent 2,339,589 describes a reusable joint for joining panes of glass. The joint is a polycarbonate strip. Different designs of strips permit joints between 2, 3 or 4 panes of glass. The strip has resilient fins which retain the glass sheets. As no adhesive is used, the panes of glass can be accidentally pulled out of the joint.

U.S. Pat. No. 6,194,508 (Wacker-Chemie) describes a peroxidically crosslinkable silicone rubber composition for jointing compounds which has reduced yellowing. The composition comprises an organosiloxane, a silicone resin and an organic peroxide.

U.S. Pat. No. 4,797,439 (Rhone Poulenc Chemie) and U.S. Pat. No. 5,833,798 (Dow Corning) describe liquid glazing sealants which are curable into an adhesive state in the presence of moisture.

The present invention seeks to provide an improved glazing joint and to address the above disadvantages.

According to a first aspect of the invention there is provided a composition for glazing joints comprising
(a) a siloxane polymer having a molecular weight of from 300,000 to 700,000;
(b) a siloxane polymer having a molecular weight of from 10,000 to 100,000; the ratio of component (a) to component (b) preferably being in the range of from 10 to 1, to 3 to 1; and
(c) a cross linking agent.

The composition is preferably sufficiently cross-linked to have an effective surface tackiness.

An advantage of the compound is that it remains adhesive (tacky). In use, this allows glass sheets to be repositioned and removed when dismantling a partition wall.

The siloxane may comprise polydimethylsiloxane (PDMS), polyvinylmethylsiloxane, polydiphenylsiloxane, polytrifluoropropylmethylsiloxane or polytrifluorovinylmethylsiloxane.

In the silicone industry, the generic term for a relatively high molecular weight, relatively viscous siloxane (like component (a)) is a “base” and the term for a relatively low molecular weight, relatively low viscosity siloxane (like component (b)) is a “fluid”. These terms will be used for components (a) and (b) throughout the present specification. However, it should be appreciated that this is not to be taken as a limitation to the identity of said components.

Advantageously the compound includes PDMS base and PDMS fluid. PDMS bases and fluids from manufacturers such as Rhodia, Dow and Wacker are suitable.

The combination of base and fluid is sufficiently crosslinked so that the compound has a surface tackiness. The ratio of base to fluid may be in the range of from 10 to 1, to 3 to 1. Preferably the ratio is 4 to 1.

Advantageously, the PDMS base has a molecular weight in the range of from 300,000 to 700,000. The base preferably has a density of about 1.16 cm³. The Shore hardness of the base may be in the range of from 10 to 95° A, preferably 40 to 90° A. The base preferably includes vinyl groups.

The compound may include from about 50 to about 95% PDMS base, preferably from about 80 to about 90%, and most preferably 86% PDMS base.

Preferably the PDMS fluid has a molecular weight in the range of from 10,000 to 100,000. The fluid preferably has a density of 0.98 s.g. Advantageously, the fluid is low viscosity (i.e. less than 100,000 centistokes). The fluid has less internal cross linking than the base. The fluid preferably does not contain any vinyl groups.

The compound may include from about 50 to about 95% PDMS fluid, preferably from about 5 to about 20%, and most preferably 13% PDMS fluid.

Preferably, the cross linking agent is a free radical initiator. The free radical initiator may be an organic peroxide. Instead of a free radical initiator, a platinum catalyst may be used. This would require very few changes to the curing process, but may eliminate the need for a hot box.

The compound may include from about 1% to about 10%, preferably 5% organic peroxide. The percentages given are percentages by weight. The amount of crosslinking agent is sufficient to result in partial cross linking of the composition so that the composition has a surface tackiness. The organic peroxide is preferably 2,4 Dichlorobenzylperoxide.

According to a second aspect of the present invention there is provided a glazing strip shaped for receiving two or more sheets wherein the surface of the strip is capable of remaining adhesive. The glazing strip preferably is formed from the composition as defined above.

An advantage is that the adhesive nature of the strip firmly secures the glass sheets in position thus reducing the likelihood that they can accidentally be pulled out of the joint. No additional adhesive is required and so there is no excess sealant to be wiped up. The strip allows the easy assembly of glass partition walls therefore.

Preferably, the strip has recesses for receiving sheets; the angle of a recess being about 65-90 degrees.

The glazing strip may be transparent, translucent or opaque. The glazing strip may be coloured for use with coloured glass.

The glazing strip may comprise polyurethane or a thermoplastics material, although these materials suffer from ageing and discolouration and have a worse performance in fire. The strip may be UV resistant.

According to a third aspect of the present invention, there is provided a method of manufacturing a compound for glazing joints as claimed comprising

(a) mixing components (a), (b), and (c) as defined above at a temperature of less than about 40 degrees Centigrade to achieve a substantially homogeneous mixture,

(b) extruding the mixture,

(c) curing the mixture at a temperature of from 100 to 900 degrees Centigrade.

Any polymer mixing technique carried out at a temperature of less than about 40° C. can be used, so long as the result is a homogeneous mixture.

Preferably, step (c) uses a hot air vulcanising unit. The method may involve an additional curing step of from 100 to 300 degrees Centigrade.

According to a fourth aspect of the present invention, there is provided a method of joining glazing sheets comprising
(a) providing an adhesive strip shaped for receiving two or more glazing sheets, the surface of the strip being inherently adhesive;
(b) inserting the strip between adjacent edges of at least a first and second sheet.

It will be apparent that the glazing strip could be used for joining glass, plastic, perspex, or opaque sheets. The glazing strip could be used in vertical or horizontal joints or joints of other angles. The strip may be used with in conjunction with a contact adhesive.

Preferred embodiments of the present invention are described below, by way of example only, with reference to the accompanying drawings, in which:

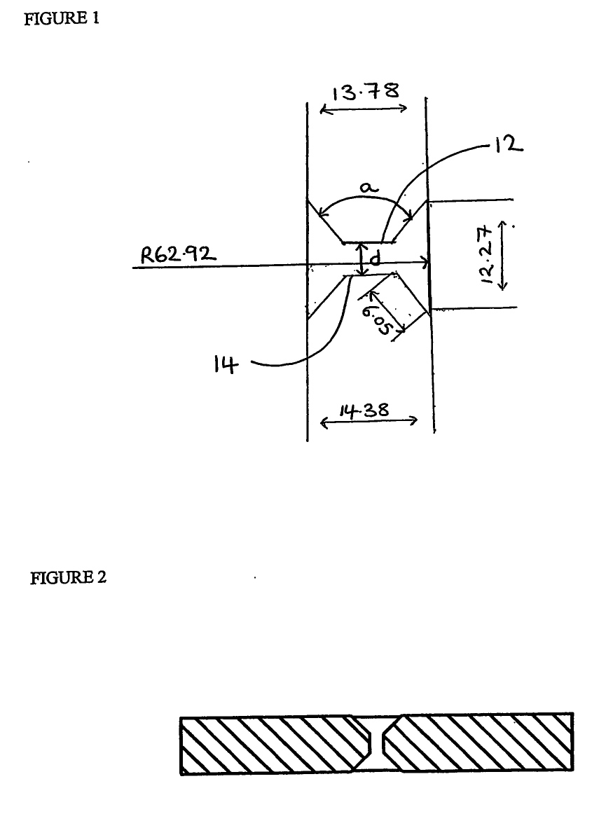

FIG. 1 is a top plan view of a glazing strip for forming a 180 degree joint;

FIG. 2 is a top plan view of a joint formed by the glazing strip in FIG. 1;

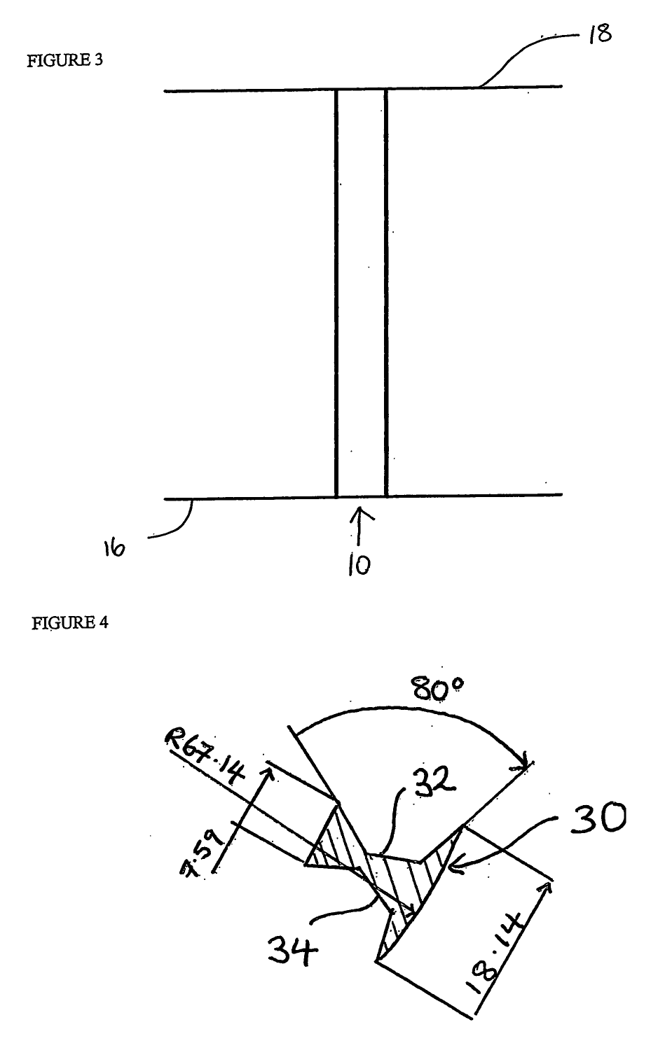

FIG. 3 is a front view of the joint in FIG. 2;

FIG. 4 is a top plan view of a glazing strip for forming a 45 degree joint;

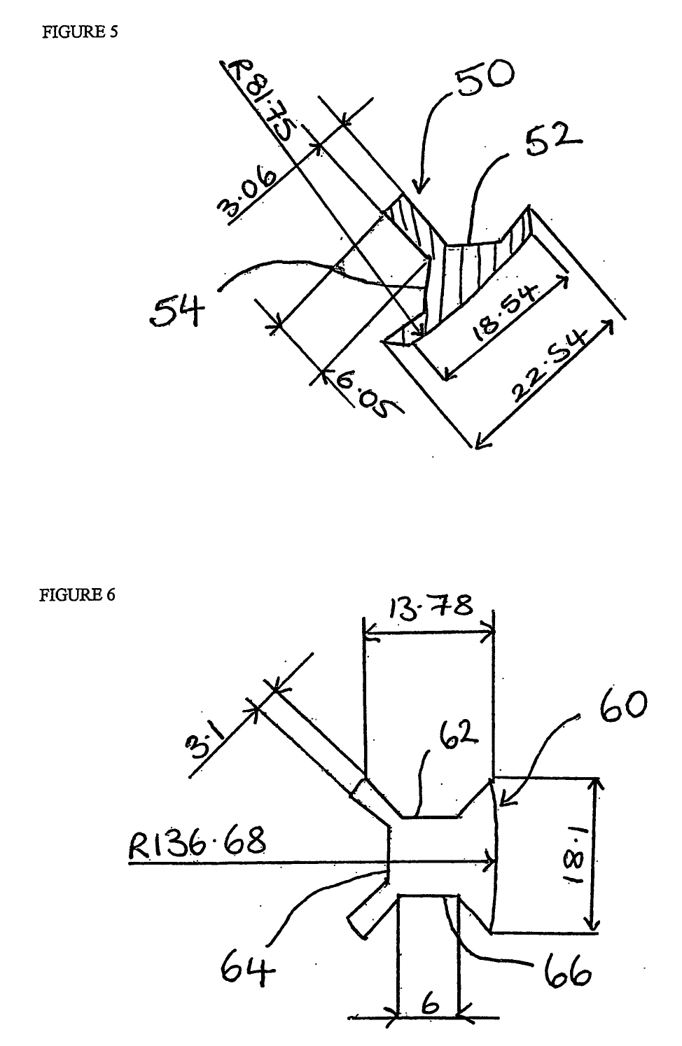

FIG. 5 is a top plan view of a glazing strip for forming a 90 degree joint; and

FIG. 6 is a top plan view a glazing strip for forming a joint between three glass sheets.

Preferred dimensions are given in mm. These can change by up to a factor of 3 or more.

Referring to FIGS. 1 to 3, a first embodiment of the glazing strip 10 has recesses 12,14 each for receiving a sheet of glass 16,18. The angle of the recess (“a”) is 80 degrees. The strip 10 forms a joint between the glass sheets 16,18 such that the sheets are firmly attached to each other. Typically, the strip 10 maintains a distance of 3 mm between the glass sheets 12,14 (distance “d”). The glazing strip 10 forms a 180 degree joint between the two adjacent sheets of glass 16,18.

The glazing strip 10 is formed by extrusion of a material which is capable of remaining of adhesive. The material is a mixture of polydimethylsiloxane (PDMS) base, (Rhodia MF180™) which is compounded with inert fillers such as fumed silica, PDMS fluid (Rhodia 47V60000™) and 2,4 dichlorobenzyl peroxide by combining the above components in a ratio of 86 (PDMS base):13 (PDMS fluid):1 (organic peroxide). Rhodia 47V60000 is a linear dimethylpolysiloxane, which has a low surface tension, good thermal stability and a viscosity of about 60,000 centistokes.

The components are mixed thoroughly in a clean environment using either an open mill or an internal mixer, at a temperature of less than 40 degrees Centigrade to avoid curing, and until a homogenous mass is achieved.

The duration of the mixing is dependant upon the size of the batch and as such varies. The resultant compound is tested for homogeneity by rheometry and specific gravity testing against a standard.

After mixing, the material is cured using a hot air vulcanising unit (hot box) which is temperature controlled to within +/−5 degrees Centigrade. The unit is set to a temperature of between about 200 and about 900 degrees Centigrade depending upon the type of production unit being used to feed extrudate to it. The duration of the curing step depends on the rate of extrusion. The temperature and rate of extrusion will vary according to the cross sectional volume of the profile. The extrusion is passed through the hot box at a rate sufficient to achieve the desired state of cure, such as either a partial (slin) cure or full (cure). In the case of a skin cure extrusion, the product will pass directly from the hot box to a curing tunnel where the extrusion will pass through a heated zone (100 to 295 degrees Centigrade) whilst supported by a moving belt. Certain sizes of extrusion will require only belt cure. The heat source is typically radiant elements but could equally be infra red or microwave.

The material is then further cured at about 200 degrees Centigrade for up to 16 hours.

This polymeric compound is designed to exhibit a certain degree of surface tackiness.

Typical physical properties of the material are as follows:

| | | TYPICAL |
|---|---|---|
| TEST | UNITS | VALUES |
| DENSITY | g/cm³ | 1.21 +/− 0.03 |
| HARDNESS | Shore °A | 60 |
| TENSILE STRENGTH | Mpa | 9.21 |
| ELONGATION @ BREAK | % | 543 |
| TEAR STRENGTH | N/mm | 38 |
| COMPRESSION SET | % | 23 |
| 24 HRS @ 100° C. | | |
| (Recovery = 20 mins. in air @ 20° C.) | | |

The material should have a good blend of physical properties.

The glazing strips can be made in a variety of sizes and thicknesses for joining glass sheets of different thickness (typically 6-16 mm), for example standard toughened or laminated glass.

In use, the appropriate sized glazing strip is chosen for the type of glass used and the angle of joint required. A first glass sheet 16 is inserted into the recess 12. The strip 10 is adhesive and so the glass sheet 16 is firmly held in place. A second glass sheet 18 is then positioned in recess 14. The edges 20,22 of the strip 10 are flush with the glass sheets 16,18.

A coating may be applied to one or both edges 20, 22 of the strip 10 by spraying or brushed on; the surface of the coating being non adhesive. A typical coating is sprayed silica. Alternatively, at least one of the edges 20, 22 of the strip may be dried such that at least the outer surface of the strip is no longer sticky.

Referring to FIG. 4, a second embodiment of the glazing strip 30 has recesses 32, 34 each for receiving a sheet of glass. The angle of the recess is 80 degrees. The adhesive strip 30 forms a 45 degree junction between the glass sheets.

Referring to FIG. 5 a third embodiment of the glazing strip 50 has recesses 52, 54 each for receiving a sheet of glass. The angle of the recess is 80 degrees. The adhesive strip so forms a 90 degree junction between the glass sheets.

The strip may be designed to permit junctions of different angles at any value between those shown in the Figures.

Referring to FIG. 6, a fourth embodiment of the glazing strip 60 has recesses 62, 64, 66 each for receiving a sheet of glass thus forming a three-way junction.

The glazing strip can have more than three recesses, for example four recesses for forming a 4-way junction.

1-19. (canceled)

20. A composition for glazing joints comprising (a) a siloxane polymer having a molecular weight of from 300,000 to 700,000; (b) a siloxane polymer having a molecular weight of from 10,000 to 100,000; the ratio of component A to component B being in the range of from 10 to 1, to 3 to 1; and (c) a cross linking agent.

21. The composition as claimed in claim 20, wherein component (a) is a polymer containing vinyl groups.

22. The composition as claimed in claim 20, wherein component (b) does not contain any vinyl groups.

23. The composition as claimed in claim 21, wherein component (b) does not contain any vinyl groups.

24. The composition as claimed in claim 20, wherein component (a) has a specific gravity of from 1.1 g cm⁻³ to 1.2 g cm⁻³

25. The composition as claimed in claim 20, wherein component (b) has a specific gravity of from s.g. 70 to 130.

26. The composition as claimed in claim 20, wherein component (a) has a Shore hardness of from 10 to 95° A.

27. The composition as claimed in claim 26, wherein component (a) has a Shore hardness of from 40 to 90° A.

28. The composition as claimed in claim 20, wherein component (b) has a viscosity of from 0.65 to 100,000 centistokes.

29. The composition as claimed in claim 28, wherein component (b) has a viscosity of from 40,000 to 80,000 centistokes.

30. The composition as claimed in claim 20, wherein component (c) is a free radical initiator.

31. The composition as claimed in claim 20, wherein component (c) is an organic peroxide.

32. The composition as claimed in claim 20, comprising from 80 to 90% component (a) by weight.

33. The composition as claimed in claim 32, comprising about 86% component (a) by weight.

34. The composition as claimed in claim 20, comprising from 5 to 20% component (b) by weight.

35. The composition as claimed in claim 34, comprising about 13% component (b) by weight.

36. The composition as claimed in claim 20, comprising from 1 to 10% component (c) by weight.

37. The composition as claimed in claim 36, comprising about 5% component (c) by weight.

38. A method of joining glazing sheets comprising (a) providing an adhesive strip shaped for receiving two or more glazing sheets, the surface of the strip being inherently adhesive; (b) inserting the strip between adjacent edges of at least a first and second sheet.

39. The method as claimed in claim 38, wherein the adhesive strip comprises (a) a siloxane polymer having a molecular weight of from 300,000 to 700,000; (b) a siloxane polymer having a molecular weight of from 10,000 to 100,000; the ratio of component A to component B being in the range of from 10 to 1, to 3 to 1; and (c) a cross linking agent.
